(19) United States
(12) Patent Application Publication
(10) Pub. No.: US 2026/0008198 A1
(43) Pub. Date: Jan. 8, 2026

(54) KITCHEN FOOD SLICER

(71) Applicant: NINGBO JINSHUN HOUSEWARE CO.,LTD, Ningbo (CN)

(72) Inventor: Renhao JIN, Ningbo (CN)

(73) Assignee: NINGBO JINSHUN HOUSEWARE CO.,LTD, Ningbo (CN)

(21) Appl. No.: 19/023,533

(22) Filed: Jan. 16, 2025

(30) Foreign Application Priority Data
Jul. 5, 2024 (CN) 202421588845.2
Jul. 31, 2024 (CN) 202421844346.5

(51) Int. Cl. B26D 3/28; B26D 1/00

(52) U.S. Cl. CPC B26D 3/28; B26D 1/0006

(57) ABSTRACT

A food slicer includes a housing. The housing includes a partition and an annular wall arranged around the partition, the partition is defined with an opening and provided with a first blade, a blade edge of the first blade is located at the opening, and the blade edge of the first blade is arranged radially. The opening of the partition is arranged with a slope at a position opposite to the blade edge of the first blade, a top end of the slope is adjustable in height, and the top end of the slope is located lower than the blade edge of the first blade to form a discharge port.

### CROSS REFERENCE TO RELATED APPLICATIONS

This application claims priority benefits to Chinese Patent Application No. 2024215888452, filed on Jul. 5, 2024; and Chinese Patent Application No. 2024218443465, filed on Jul. 31, 2024; the contents of which are incorporated herein by reference.

### TECHNICAL FIELD

The present disclosure relates to a household food cutting tool, particularly, relates to a kitchen food slicer.

### BACKGROUND

A food slicer is a tool used for shredding fruits and vegetables. Traditional food slicers include a board with a surface covered in grating holes. This type of board food slicer is used for shredding ingredients like radishes. The shreds produced by a board food slicer are generally short because it can only create straight shreds. As a result, the length of the radish shreds is always shorter than the original length of the radish, typically only about one-third of its original length, which may not meet user needs.

### SUMMARY

A first aspect of the present disclosure provides a food slicer, including a housing. The

housing includes a partition and an annular wall arranged around the partition, the partition is defined with an opening and provided with a first blade, a blade edge of the first blade is located at the opening, and the blade edge of the first blade is arranged radially. The opening of the partition is arranged with a slope at a position opposite to the blade edge of the first blade, a top end of the slope is adjustable in height, and the top end of the slope is located lower than the blade edge of the first blade to form a discharge port.

A second aspect of the present disclosure provides a food slicer, including a housing. The housing includes a base, a partition and a annular ring, the base is cylindrical, the partition is placed on a top surface of the base, a top of an inner wall of the annular ring has a pressing ring extending inwardly, the annular ring is detachably sleeved on an upper portion of the base, the pressing ring is abutted against the partition, a middle portion of the partition is provided with a plug-in post extending upwardly, the partition is defined with an opening and provided with a first blade, a blade edge of the first blade is located at the opening, the blade edge of the first blade being arranged radially, and a discharge port is formed between the blade edge of the first blade and the opening.

### BRIEF DESCRIPTION OF DRAWINGS

The drawings constituting a part of the present disclosure are configured to provide a further understanding of the present disclosure. The embodiments of the present disclosure and their descriptions are used for explaining and do not constitute an improper limitation on the present disclosure.

FIG. 1 is a perspective view in accordance with the embodiments of the present disclosure.

FIG. 2 is a perspective view in accordance with the embodiments of the present disclosure.

FIG. 3 is a sectional view taken along an axial direction of a transmission screw in accordance with the embodiments of the present disclosure.

FIG. 4 is a sectional view taken along an axial direction of a damping member in accordance with the embodiments of the present disclosure.

FIG. 5 is an exploded view in accordance with the embodiments of the present disclosure.

FIG. 6 is another exploded view in accordance with the embodiments of the present disclosure.

FIG. 7 is a perspective view in accordance with the embodiments of the present disclosure.

FIG. 8 is a perspective view with the base removed in accordance with the embodiments of the present disclosure.

FIG. 9 is a perspective view in accordance with the embodiments of the present disclosure.

FIG. 10 is another perspective view in accordance with the embodiments of the present disclosure.

FIG. 11 is sectional view taken along a longitudinal direction of a first blade seat in accordance with the embodiments of the present disclosure.

FIG. 12 is a sectional view taken along a longitudinal direction of a second blade seat in accordance with the embodiments of the present disclosure.

FIG. 13 is a sectional view in accordance with the embodiments of the present disclosure.

FIG. 14 is a perspective, partially exploded view showing a cleaning and disassembled state in accordance with the embodiments of the present disclosure.

FIG. 15 is a perspective view of a slicing component in accordance with the embodiments of the present disclosure.

FIG. 16 is another perspective view of a slicing component in accordance with the embodiments of the present disclosure.

FIG. 17 is a perspective view of a slicing component installed in a partition in accordance with the embodiments of the present disclosure.

FIG. 18 is a perspective view of a base in accordance with the embodiments of the present disclosure.

### DETAILED DESCRIPTION OF THE EMBODIMENTS

The present disclosure may be described in detail below with reference to the accompanying drawings and in conjunction with various embodiments. Each example is provided to explain but not limit the present disclosure. In fact, it may be clear to those of ordinary skill that modifications and variations may be made without departing from the scope or spirit of the present disclosure. For example, a feature shown or described as part of some embodiments may be used according to another embodiment to produce yet another embodiment. Therefore, it is intended that the present disclosure includes such modifications and variations within the scope of the appended claims and their equivalents.

In the description of the present disclosure, the terms “longitudinal”, “lateral”, “upper”, “lower”, “front”, “back”, “left”, “right”, “vertical”, “horizontal”, “top”, “bottom” and the like indicate the orientational or positional relationship based on the orientational or positional relationship illustrated in the drawings, which is only for the convenience of describing and does not require the present disclosure to be constructed and operated in a specific orientation, and therefore cannot be understood as limiting the present disclosure. The terms “connected”, “connecting” and “arranged” used in the present disclosure should be understood in a broad sense. For example, it may be a fixed connection or a detachable connection; it may be directly connected or indirectly connected through an intermediate component; it may also be a wired electrical junction, a radio connection, or a wireless signal connection. For those of ordinary skill in the art, the specific meanings of the above terms may be understood according to the specific circumstances.

One or more examples of the present disclosure are illustrated in the attached drawings. Numbers and letter signs are used in the detailed description to refer to features in the drawings. Similar signs in the drawings and descriptions have been configured to refer to similar parts of the present disclosure. As used herein, the terms “first”, “second” and “third” are used interchangeably to distinguish one component from another and are not intended to indicate the position or importance of individual components.

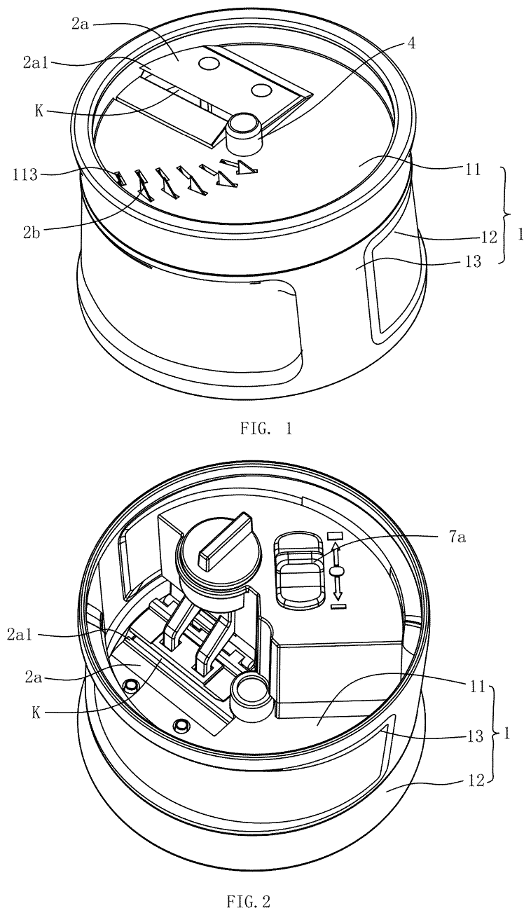

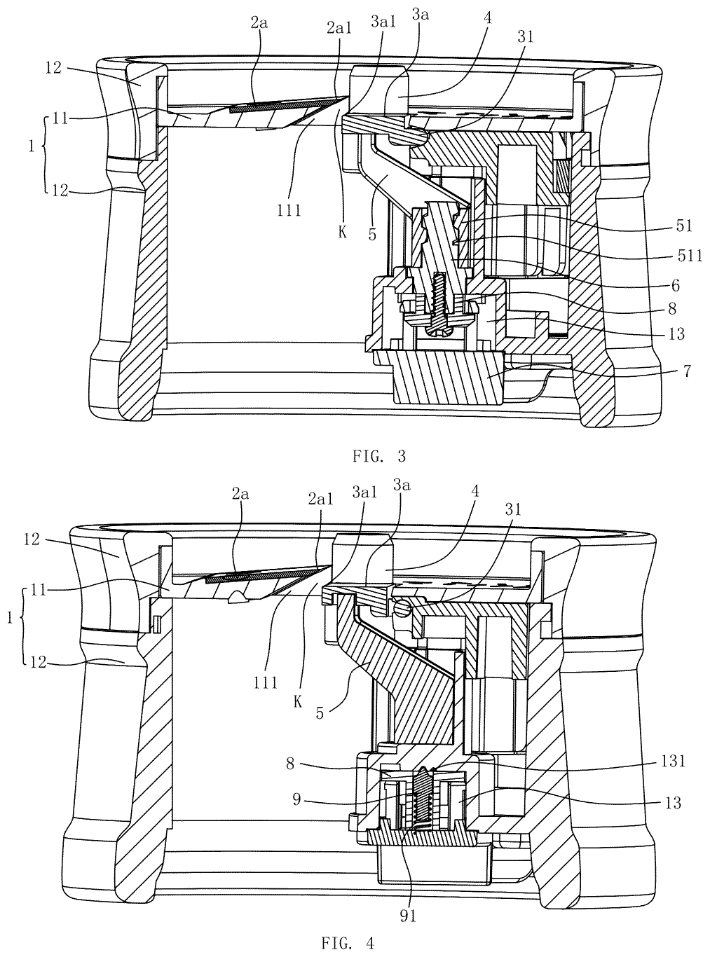

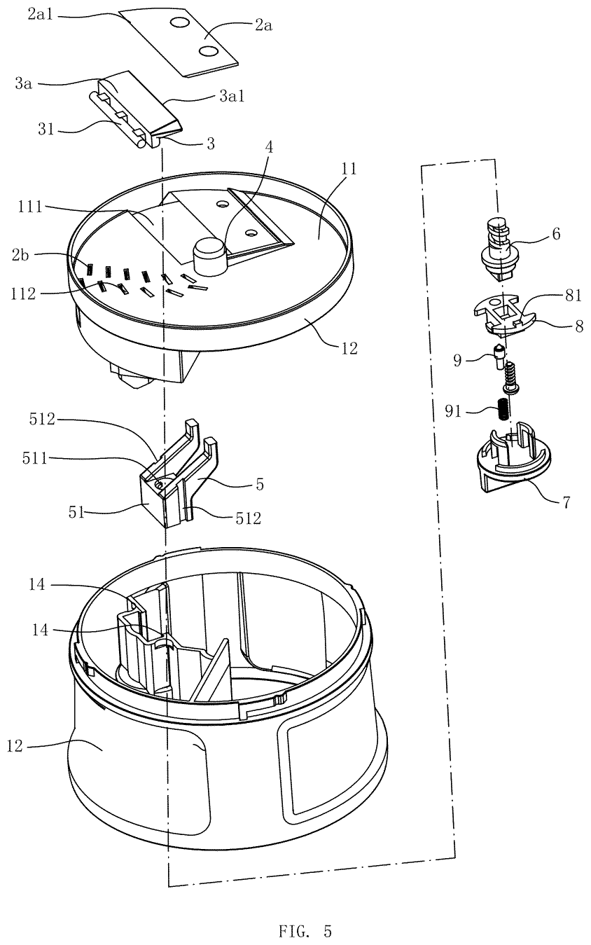

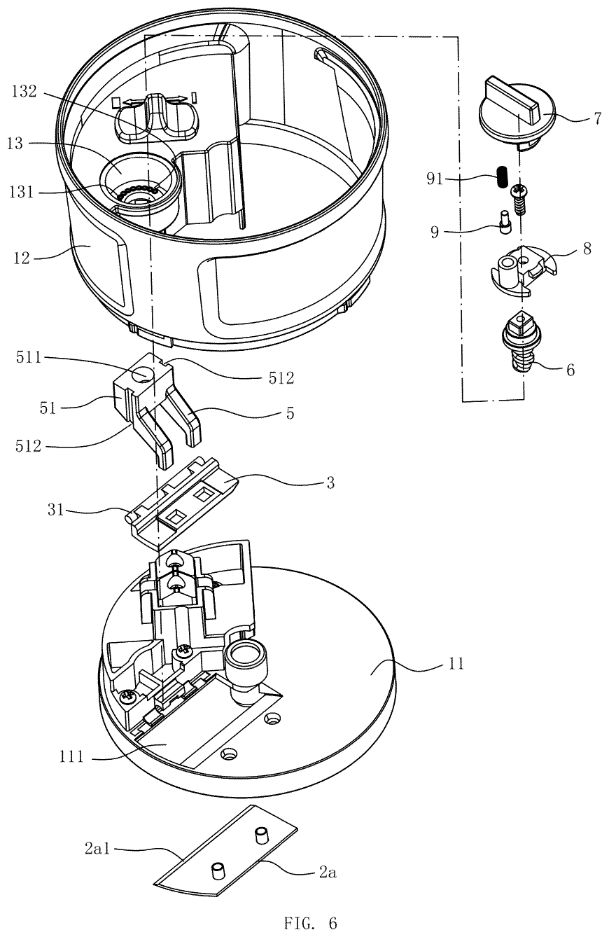

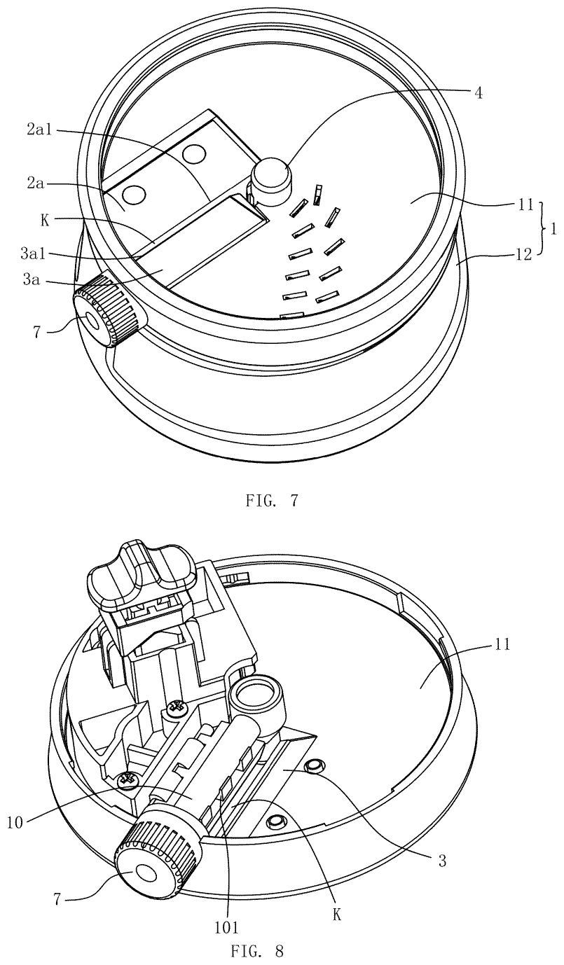

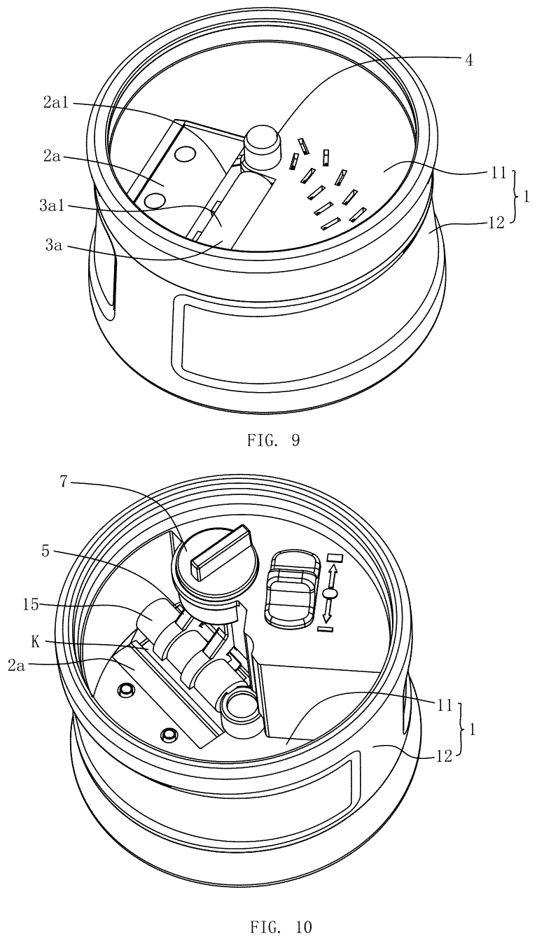

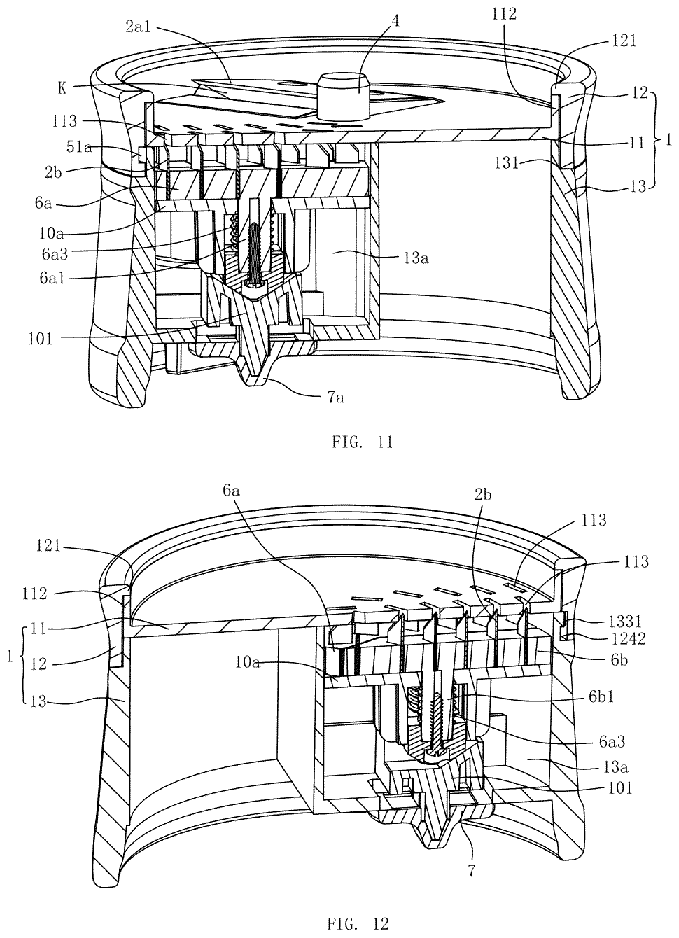

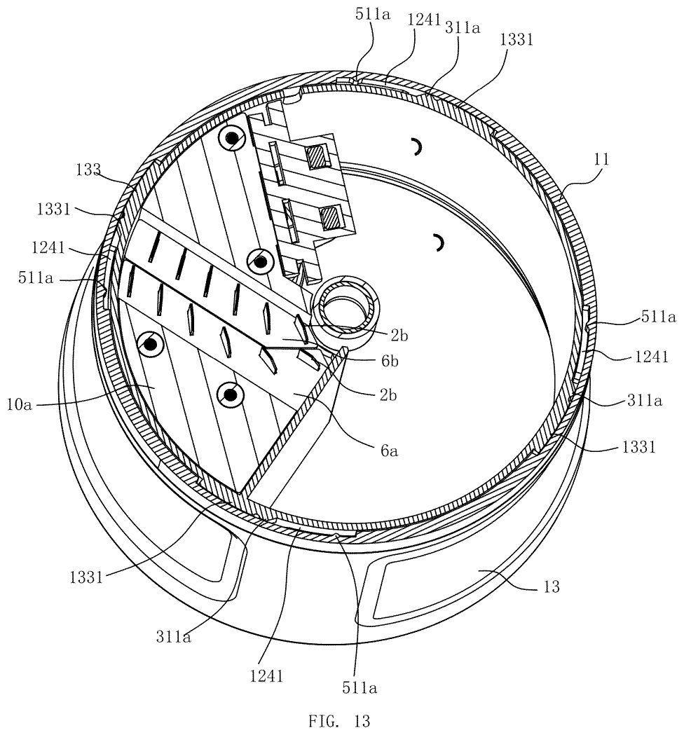

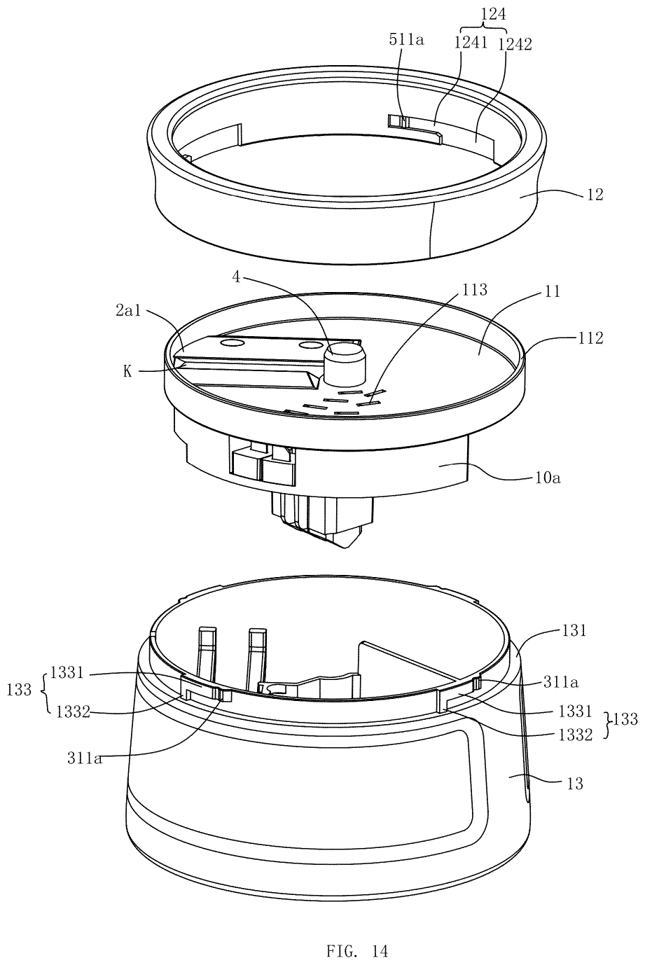

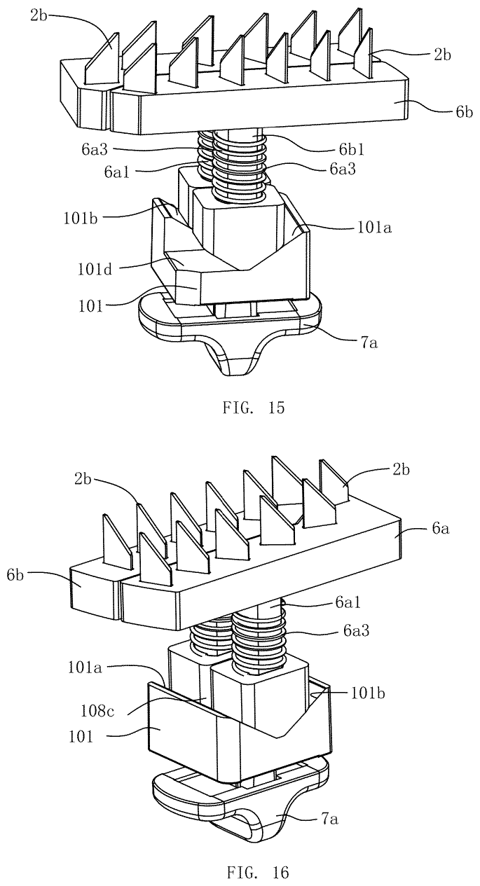

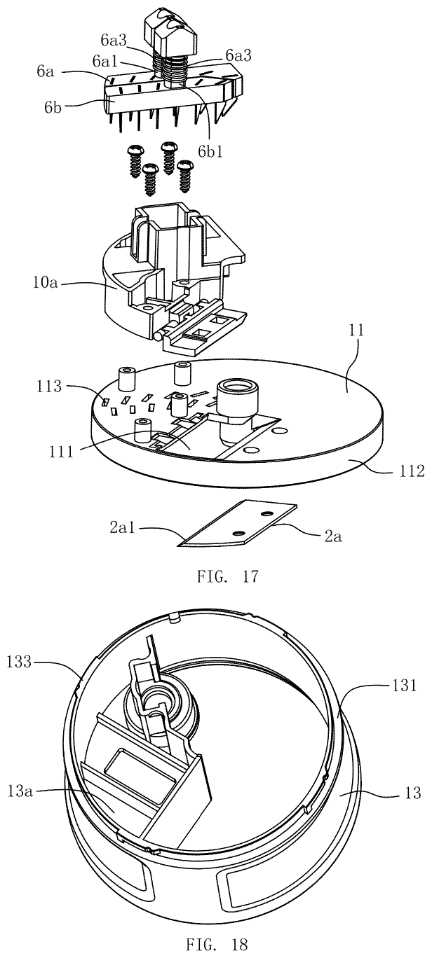

As shown in the FIG. 1 to FIG. 18, the embodiments of the present disclosure are presented as follows.

A food slicer includes a housing 1, the housing 1 has a transversely arranged partition 11 and a vertically arranged annular ring 12 located around the partition 11. A middle portion of the partition 11 is provided with a plug-in post 4 having a center hole extending upward, and the center hole of the plug-in post 4 runs through the partition 11. The partition 11 is provided with an opening 111 and a first blade 2a, and a blade edge 2a1 of the first blade 2a is located at the opening 111. The blade edge 2a1 of the first blade 2a is arranged radially along the partition 11. The partition 11 can be integrally formed with the base or can be an independent component.

The opening 111 of the partition 11 is provided with a slope 3a at a position opposite to the blade edge 2a1 of the first blade 2a, and a height of a top 3a1 of the slope 3a can be adjusted. In operation, the top 3a1 of the slope 3a is located at a position lower than a position of the blade edge 2a1 of the first blade 2a to form a discharge port K between them. One side, facing the discharge port K, of the partition 11 is defined with a plurality of blade holes 113. A plurality of second blades 2b are provided vertically below the blade holes 113, allowing the second blades 2b to extend upward or hide downward in the blade holes 113.

The slope 3a in the embodiments is an upper surface of an adjusting plate 3 and an inclination angle of the slope 3a is adjustable. One side, proximal to the blade edge 2a1 of the first blade 2a, of the adjusting plate 3, is the top 3a1 of the slope 3a. The adjusting plate 3 is arranged radially, and another side, away from the blade edge 2a1 of the first blade 2a, is hinged to the partition 11. A pivot 31 is provided on the adjusting plate 3, and the pivot 31 is rotatably mounted on the partition 11.

A supporting claw 5 for controlling the inclination angle of the adjusting plate 3 is provided below the adjusting plate 3. The supporting claw 5 is capable of moving up and down and to be linked with the side, proximal to the blade edge 2a1 of the first blade 2a, of the adjusting plate 3. The food slicer also includes a transmission screw 6 constrained in the housing 1 and capable of rotating around its own axis. The supporting claw 5 is fixed on a sliding block 51. In some embodiments, the supporting claw 5 and the sliding block 51 are integrally formed together. The sliding block 51 is provided with a threaded hole 511. The transmission screw 6 is threadedly connected in the threaded hole 511. The sliding block 51 is constrained in the housing 1 through the slide-groove guiding structure and can only move up and down. Each of two side walls of the sliding block 51 is provided with a slide groove 512, and each of two inner walls of the housing 1 is provided with a guide block 14 that is slidably matched with a corresponding slide groove 512. A head portion of the transmission screw 6 is connected to a knob 7 to allow it to be driven to rotate by the knob 7.

The housing 1 is provided with a mounting chamber 13, the head portion of the transmission screw 6 runs through a top wall of the mounting chamber 13 and enters the mounting chamber 13. The head portion of the transmission screw 6 is fixed with a transition connection block 8 by a screw, the knob 7 is connected to the transition connection block 8 to drive the transition connection block 8 to rotate, the transition connection block 8 is provided with a damping member 9 abutted by a spring 91, the top wall of the mounting chamber 13 is provided with a plurality of positioning pits 131 arranged at intervals along the peripheral, and the damping member 9 is kept stuck in a corresponding positioning pit 131 under the force of the spring 91. The top wall of the mounting chamber 13 is provided with a stop boss 132, and the transition connection block 8 is provided with a stop block 81. When the transition connection block 8 rotates to two extreme positions, the stop boss 132 blocks the stop block 81.

Compared with the related art, this food slicer has the function of adjusting the thickness of the slices or the shreds. The specific working principle and process of adjustment are as follows.

Turn the knob 7, which drives the transmission screw 6 to rotate and further drives the supporting claw 5 to move upward, and then pushes the adjusting plate 3 to swing upward, the top 3a1 of the slope 3a moves upward, and the discharge opening K formed between the top 3a1 of the slope 3a and the blade edge 2a1 of the first blade 2a becomes smaller, then the thickness of the food being cut becomes thinner. When the supporting claw 5 moves downward, the food exerts a downward pressure on the adjusting plate 3, driving the adjusting plate 3 to swing downward, and the discharge opening K formed between the top 3a1 of the slope 3a and the blade edge 2a1 of the first blade 2a becomes larger, and the thickness of the food being cut becomes thicker. In this way, the thickness of the cut food is adjusted.

In some embodiments, a driving shaft 10 for controlling the inclination angle of the adjusting plate 3 is provided below the adjusting plate 3, and the rotation of the driving shaft 10 is eccentrically linked with the adjusting plate 3. The driving shaft 10 runs through the annular ring 12 of the housing 1 and is connected to the knob 7. In some embodiments, a side-convex eccentric block 101 is provided on a peripheral wall of the driving shaft 10, allowing the rotation of the driving shaft 10 to drive the adjusting plate 3 to swing

In some embodiments, the slope 3a is a portion of an arc surface of a horizontally arranged cylinder 15 that is exposed above the partition 11. The cylinder 15 is a roller that can rotate around its own axis. The cylinder 15 can also be a non-rotating one. A height of the cylinder 15 is adjustable up and down. The cylinder 15 is connected to the supporting claw 5 below it, and the supporting claw 5 moves up and down to adjust the height of the cylinder 15. The food slicer also includes a transmission screw 6 that is constrained in the housing 1 and can rotate around its own axis. The supporting claw 5 is fixed on a sliding block 5, and the sliding block 5 is provided with a threaded hole 51. The transmission screw 6 is threadedly connected in the threaded hole 51, and the sliding block 5 is constrained in the housing 1 by the slide rail guide groove structure and can only move up and down. The head portion of the transmission screw 6 is connected to the knob 7 so as to be driven to rotate by the knob 7. The structures and matching relationship of the transmission screw 6, the supporting claw 5 and the knob 7 are the same as described above.

In some embodiments, a food slicer includes a housing 1. The housing 1 includes a base 13, a partition 11 and an annular ring 12. The base 13 is cylindrical. The partition 11 is placed on a top surface of the base 13. A top of an inner wall of the annular ring 12 has an inwardly convex pressing ring 121. The annular ring 12 is sleeved on an upper portion of the base 13 and is detachably connected to the base 13. The pressing ring 121 is abutted tightly on the partition 11.

A middle portion of the partition 11 is provided with an upwardly extending plug-in post 4, and the plug-in post 4 is hollow. The partition 11 is defined with an opening 111 and provided with a blade 2a. A blade edge 2a1 of the blade 2a is located at the opening 111 to forms a discharge port K between the opening 111 and the blade edge 2a1 of the blade 2a. The blade edge 2a1 of the blade 2a is arranged radially.

An outwardly protruding shoulder 131 is provided on an outer peripheral wall of an upper portion of the base 13. When the annular ring 12 is fixed on the base 13, a bottom of the annular ring 12 rests on the shoulder 131. The annular ring 12 is fixed on the base 13 by means of threads or screws. A periphery of a top surface of the partition 11 has an annular wall 112 extending upward, and the pressure ring 131 is abutted on the top of the annular wall 112.

In some embodiments, an outer peripheral wall of the base 13 is provided with a plurality of ribs 133 arranged at intervals, and an inner wall of the annular ring 12 is provided with a plurality of grooves 124 matching the ribs 133. Each rib 133 includes a transverse rib 1331 and a vertical rib 1332, and the vertical rib 1332 is connected to a tail end of the transverse rib 1331 and extends downward. Each groove 124 includes a transverse groove 1241 and a vertical groove 1242, and the vertical groove 1242 is connected to a head portion of the transverse groove 1241 and extends downward to run through a bottom surface of the annular ring 12. Each transverse rib 1331 can pass through a corresponding vertical groove, and the rotating annular ring allows each transverse rib 1331 to be snapped into a corresponding transverse groove 1241. A surface of each transverse rib 1331 is provided with a first snap-fit point 311a, and a bottom surface of each transverse groove 1241 is provided with a second snap-fit point 511a that is snap-fitted with the first snap-fit point 311a.

The partition 11 is defined with a plurality of blade holes 113, and a bottom surface of the partition 11 is provided with a slicing component, and a plurality of second blades 2b arranged in the slicing component can extend out of or retract into the blade hole 123. A mounting seat 10a is fixed on the partition 11, and the slicing component is arranged in the mounting seat 10a. The slicing component includes a first blade seat 6a and a second blade seat 6b adjacent to each other.

The first blade seat 6a and the second blade seat 6b are both provided with second blades 2b extending upward. The first blade seat 6a is fixed with a first push rod 6a1 extending downward, and the second blade seat 6b is fixed with a second push rod 6b1 extending downward. The first push rod 6a1 and the second push rod 6b1 are constrained in the mounting seat 10a and can only move up and down. Each of the first push rod 6a1 and the second push rod 6a2 are provided with a spring 6a3 to allow the first push rod and the second push rod to be capable of moving downward. The food slicer also includes a switch 7a for driving the first push rod 6a1 and/or the second push rod 6b1 to move up and down.

The base 13 is provided with a concave cavity 13a with an opening facing upward, and a partition 11 covers the opening of the concave cavity 13a. The mounting seat 10a is accommodated in the concave cavity 13a, and a switch 7a is constrained at a bottom of the concave cavity 13a. An operating end of the switch 7a runs through a bottom of the concave cavity 13a. A driving block 101 that can reciprocate synchronically with the switch 7a in the horizontal direction is fixed to an inner end of the switch 7a. The driving block 101 has a right driving surface 101a that gradually tilts downward from right to left and a left driving surface 101b that gradually tilts downward from left to right. There is a recessed portion 101c between the right driving surface 101a and the left driving surface 101b. The left driving surface 101b has a notch 8d. The driving block 101 can be in contact with lower ends of the first push rod 6a1 and the second push rod 6b1. When the driving block 101 is at zero position, the lower ends of the first push rod 6a1 and the second push rod 6b1 are sunk into the recessed portion 101c, and the first blade seat 6a and the second blade seat 6b are in a lower position. When the driving block 101 is translated from right to left from the zero position, the right driving surface 101a acts on the lower ends of the first push rod 6a1 and the second push rod 6b1 synchronically and pushes them both to move upward. When the driving block 101 is translated from left to right from the zero position, the left driving surface 101b can only act on the first push rod 6a1 and push it to move upward, and the second push rod 6b1 slides in the notch 8d.

The food slicer provided by the embodiments of the present disclosure is easy to clean. When cleaning, the annular ring 12 and the base 13 are screwed off and disconnected, allowing the partition 11 to be washed separately more conveniently. Vegetables left on the blades 2a, the blade holes 113 and the plug-in post 4 on the partition 11 can be cleaned more easily. When in use, the partition 11 can be placed on the top surface of the base 13, and the annular ring 12 can be screwed in and connected to the base 13, and the pressure ring 131 in the annular ring 12 can be abutted on the partition 11 to fix the partition 11 relative to the base 13.

The above description only illustrates some embodiments of the present disclosure and is not intended to limit the scope of the present disclosure. Any equivalent changes or modifications made according to the structure, characteristics and principles described in the protection scope of the present disclosure should be included in the protection scope of the present disclosure.

What is claimed is:

1. A food slicer, comprising a housing, the housing comprising a partition and an annular wall arranged around the partition, the partition being defined with an opening and provided with a first blade, a blade edge of the first blade being located at the opening, and the blade edge of the first blade being arranged radially; the opening of the partition being arranged with a slope at a position opposite to the blade edge of the first blade, a top end of the slope being adjustable in height, and the top end of the slope being located lower than the blade edge of the first blade to form a discharge port.

2. The food slicer according to claim 1, wherein the slope is an upper surface of an adjusting plate, an inclination angle of the slope is adjustable, and a first side of the adjusting plate is the top end of the slope.

3. The food slicer according to claim 2, wherein the adjusting plate is arranged radially; and a second side of the adjusting plate is hinged to the partition.

4. The food slicer according to claim 1, wherein the slope is a portion of an arc surface of a cylinder horizontally arranged and exposed above the partition.

5. The food slicer according to claim 4, wherein the cylinder is a roller configured to rotate around an axis of the roller, and a height of the cylinder is adjustable.

6. The food slicer according to claim 1, wherein a plug-in post having a center hole extending upward is provided in a middle portion of the partition, and the center hole of the plug-in post runs through the partition.

7. The food slicer according to claim 2, wherein a supporting claw for controlling the inclination angle of the adjusting plate is provided below the adjusting plate, and the supporting claw is configured to move up and down and link with the first side of the adjusting plate.

8. The food slicer according to claim 7, further comprising a transmission screw constrained in the housing and configured to rotate around an axis of the transmission screw, the supporting claw is fixed on a sliding block, the sliding block is defined with a threaded hole, the transmission screw is threadedly connected in the threaded hole, and the sliding block is constrained in the housing and is only configured to move up and down.

9. The food slicer according to claim 8, wherein a head portion of the transmission screw is connected to a knob so as to be driven by the knob to rotate.

10. The food slicer according to claim 9, wherein the housing is provided with a mounting chamber, the head portion of the transmission screw runs through a top wall of the mounting chamber and extends into the mounting chamber, a transition connection block is fixed to the head portion of the transmission screw, the knob is connected to the transition connection block to drive the transition connection block to rotate, and a damping member abutted by a spring is provided in the transition connection block, the top wall of the mounting chamber is provided with a plurality of positioning pits arranged at intervals, and the damping member is restricted in the plurality of positioning pits under a force of the spring, the top wall of the mounting chamber is provided with a stop boss, the transition connection block is provided with a stop block, and the stop boss blocks the stop block in response to the transition connection block rotating to a first position or a second position.

11. The food slicer according to claim 2, wherein a driving shaft for controlling the inclination angle of the adjusting plate is provided below the adjusting plate.

12. The food slicer according to claim 11, wherein the driving shaft runs through the annular wall of the housing and is connected to the knob.

13. The food slicer according to claim 4, wherein the cylinder is connected to a supporting claw, and the supporting claw is configured to move up and down to adjust a position of the cylinder.

14. The food slicer according to claim 13, further comprising a transmission screw constrained in the housing and configured to rotate around an axis of the transmission screw, the supporting claw is fixed on a sliding block, the sliding block is provided with a threaded hole, the transmission screw is threadedly connected in the threaded hole, and the sliding block is constrained in the housing and is configured to only move up and down.

15. The food slicer according to claim 14, wherein a head portion of the transmission screw is connected to a knob so as to be driven to rotate by the knob.

16. The food slicer according to claim 1, wherein the partition is defined with a plurality of blade holes at a position proximal to one side of the discharge port, a plurality of second blades is arranged vertically and below the plurality of blade holes, and the plurality of second blades is configured to move upward out of or downward into the plurality of blade holes.

17. A food slicer, comprising a housing; the housing comprising a base, a partition, and a annular ring; the base being cylindrical, the partition being placed on a top surface of the base, a top of an inner wall of the annular ring having a pressing ring extending inwardly, the annular ring being detachably sleeved on an upper portion of the base, the pressing ring being abutted against the partition, a middle portion of the partition being provided with a plug-in post extending upwardly, the partition being defined with an opening and provided with a first blade, a blade edge of the first blade being located at the opening, the blade edge of the first blade being arranged radially, and a discharge port being formed between the blade edge of the first blade and the opening.

18. The food slicer according to claim 17, wherein the annular ring is fixed to the base by means of threading or snap-fitting.

19. The food slicer according to claim 18, wherein a shoulder protruding outwardly is provided on an outer peripheral wall of the upper portion of the base, and a bottom of the annular ring rests on the shoulder.

20. The food slicer according to claim 18, wherein an outer peripheral wall of an upper portion of the base is arranged with a plurality of ribs at intervals, and the inner wall of the annular ring is defined with a plurality of grooves matching the plurality of ribs.

21. The food slicer according to claim 20, wherein each rib of the plurality of ribs comprises a transverse rib and a vertical rib, and the vertical rib extends downward and is connected to a tail end of a corresponding transverse rib; each groove of the plurality of grooves comprises a transverse groove and a vertical groove, and the vertical groove is connected to a head portion of a corresponding transverse groove and extends downward to run through a bottom of the annular ring; the transverse rib is configured to pass through a corresponding vertical groove, and the annular ring allows the transverse rib to be limited in a corresponding transverse groove.

22. The food slicer according to claim 21, wherein a surface of each transverse rib is provided with a first snap-fit point, and a bottom surface of each transverse groove is provided with a second snap-fit point configured to be locked with a corresponding first snap-fit point.

23. The food slicer according to claim 17, wherein a periphery of a top surface of the partition comprises an annular wall extending upward, and the pressing ring is abutted on a top of the annular wall.

24. The food slicer according to claim 17, wherein the partition is provided with a plurality of blade holes, a bottom surface of the partition is provided with a slicing component having a plurality of second blades extending upward, the plurality of second blades is configured to extend out of or retract into the plurality of blade holes, a mounting seat is fixed on the partition, and the slicing component is arranged in the mounting seat.

25. The food slicer according to claim 24, wherein the slicing component comprises a first blade seat and a second blade seat adjacent to each other and arranged in the mounting seat, the first blade seat and the second blade seat are both provided with at least two of the plurality of second blades, the first blade seat is fixed with a first push rod extending downward, the second blade seat is fixed with a second push rod extending downward, the first push rod and the second push rod are constrained in the mounting seat to be only configured to move up and down, each of the first push rod and the second push rod are provided with a spring to allow the first push rod and the second push rod to move downward, and slicing component further comprises a switch for driving the first push rod and/or the second push rod to move up and down.

26. The food slicer according to claim 25, wherein the base is provided with a cavity having an opening facing upward, the partition covers the opening of the cavity, the mounting seat is accommodated in the cavity, the switch is constrained at a bottom of the cavity, an operating end of the switch runs through the bottom of the cavity, a driving block configured to reciprocate with the switch in a horizontal direction is fixed to an inner end of the switch, the driving block has a right driving surface that tilts downward from right to left and a left driving surface that tilts downward from left to right, and a recessed portion is provided between the right driving surface and the left driving surface, the left driving surface has a notch, and the driving block is configured to contact lower ends of the first push rod and the second push rod; when the driving block is at a zero position, the lower ends of the first push rod and the second push rod are both sunk into the recessed portion, and the first blade seat and the second blade seat are in a lower position; when the driving block is translated from the zero position from right to left, the right driving surface pushes the lower ends of the first push rod and the second push rod synchronically to move upward;
and when the driving block is translated from the zero position from left to right, the left driving surface is only configured to push the first push rod to move upward and the second push rod slides in the notch.
